(19) United States
(12) Patent Application Publication
(10) Pub. No.: US 2026/0059600 A1
(43) Pub. Date: Feb. 26, 2026

(54) METHODS AND APPARATUS FOR RADIO LINK FAILURE AND RECOVERY IN MULTIPATH SIDELINK RELAYS

(71) Applicant: InterDigital Patent Holdings, Inc., Wilmington, DE (US)

(72) Inventors: Martino Freda, Laval (CA); Oumer Teyeb, Montreal (CA); Tuong Hoang, Montreal (CA); Ananth Kini, Conshohocken, PA (US)

(73) Assignee: InterDigital Patent Holdings, Inc., Wilmington, DE (US)

(21) Appl. No.: 19/100,060

(22) PCT Filed: Aug. 2, 2023
(86) PCT No.: PCT/US23/29319

§ 371 Date: Jan. 30, 2025

Related U.S. Application Data
(60) Provisional application No. 63/394,783, filed on Aug. 3, 2022.
(60) Provisional application No. 63/421,856, filed on Nov. 2, 2022.

(51) Int. Cl. H04W 76/19; H04B 17/318; H04W 76/14; H04W 76/18; H04W 88/04; H04W 92/18

(52) U.S. Cl. CPC H04W 76/19; H04B 17/328; H04W 76/14; H04W 76/18; H04W 88/04; H04W 92/18

(57) ABSTRACT

This disclosure pertains to methods and apparatus for radio link failure, radio link monitoring, and/or radio link recovery in multipath wireless communications. For example, a method implemented by a first WTRU includes receiving configuration information indicating a first and a second radio link configuration and a first and a second threshold, where the first threshold is greater 2024/030493 than the second threshold; determining that uplink data is pending for transmission on a first transmission to a network entity via a second WTRU, where the first transmission is associated with a first communication link; determining a channel condition of a second transmission from the network entity, where the second transmission is associated with a second communication link; and performing a first radio link procedure using the first radio link configuration based on a measurement of the channel condition being greater than the second threshold and less than the first threshold.

### CROSS-REFERENCE TO RELATED APPLICATIONS

This application claims priority to and the benefit of U.S. Provisional Application No. 63/394,783 filed in the U.S. Patent and Trademark Office on Aug. 3, 2022, and U.S. Provisional Application No. 63/421,856 filed in the U.S. Patent and Trademark Office on Nov. 2, 2022, the entire contents of each of which being incorporated herein by reference as if fully set forth below in their entirety and for all applicable purposes.

### FIELD

This disclosure pertains to wireless communications. For example, one or more embodiments disclosed herein are related to methods and apparatus for radio link failure, radio link monitoring, and/or radio link recovery in wireless transmit/receive units that have dual connectivity to a network via a direct network connection (e.g., direct connection to a network entity) and/or connection to the network through a relay wireless transmit/receive unit.

### SUMMARY

One or more embodiments disclosed herein are related to methods and apparatus for radio link failure (RLF) and recovery in multipath wireless communications.

In one embodiment, a method implemented by a WTRU for wireless communications includes receiving configuration information indicating 1) a first radio link configuration and a second radio link configuration and 2) a first threshold and a second threshold, where the first threshold is greater than the second threshold; determining that uplink data is pending for transmission on a first transmission to a network entity via a second WTRU, where the first transmission is associated with a first communication link; determining a channel condition of a second transmission from the network entity, where the second transmission is associated with a second communication link; and performing a first radio link procedure using the first radio link configuration based on a measurement of the channel condition being greater than the second threshold and less than the first threshold.

In one embodiment, a WTRU for wireless communications comprising circuitry, including a transmitter, a receiver, a processor, and memory, is configured to receive configuration information indicating 1) a first radio link configuration and a second radio link configuration and 2) a first threshold and a second threshold, where the first threshold is greater than the second threshold; determine that uplink data is pending for transmission on a first transmission to a network entity via a second WTRU, where the first transmission is associated with a first communication link; determine a channel condition of a second transmission from the network entity, where the second transmission is associated with a second communication link; and perform a first radio link procedure using the first radio link configuration based on a measurement of the channel condition being greater than the second threshold and less than the first threshold.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to one or more embodiments;

FIG. 1D is a system diagram illustrating a further example RAN and a further example CN that may be used within the communications system illustrated in FIG. 1A according to one or more embodiments;

FIG. 2 is a diagram showing the protocol view of a split bearer in dual connectivity;

FIG. 3 is a diagram showing RLC configuration in dual connectivity when data duplication is employed;

FIG. 4 is a diagram illustrating the protocol stack of the user plane of the L2 U2N Relay architecture;

FIG. 5 is a diagram illustrating the protocol stack of the control plane of the L2 U2N Relay architecture;

FIG. 6 is a diagram illustrating a multipath model at the protocol stack level for a WTRU in dual connectivity wherein both connection paths are to the same cell;

FIG. 7 is a diagram illustrating a multipath model at the protocol stack level for a WTRU in dual connectivity wherein the two connection paths are through different cells;

FIG. 8 is a flowchart illustrating RLM/RLF processing for a dual connectivity WTRU, according to one or more embodiments;

FIG. 9 is a flowchart illustrating radio link re-establishment for a dual connectivity WTRU, according to one or more embodiments;

FIG. 10A is a diagram illustrating an example of multipath wireless communications, according to one or more embodiments; and

FIG. 10B is a flowchart illustrating an example procedure of RLM and/or RLF detection in multipath communications, according to one or more embodiments.

### DETAILED DESCRIPTION

### Introduction

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communication Systems

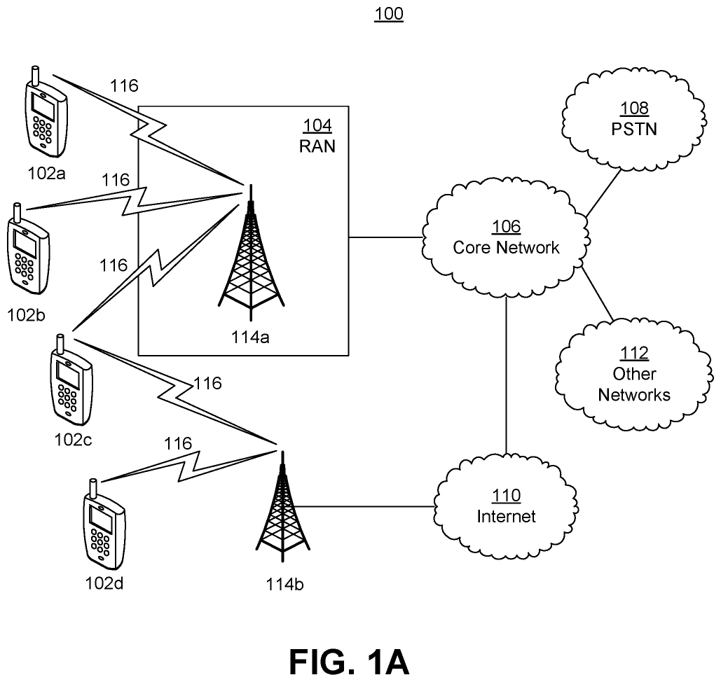

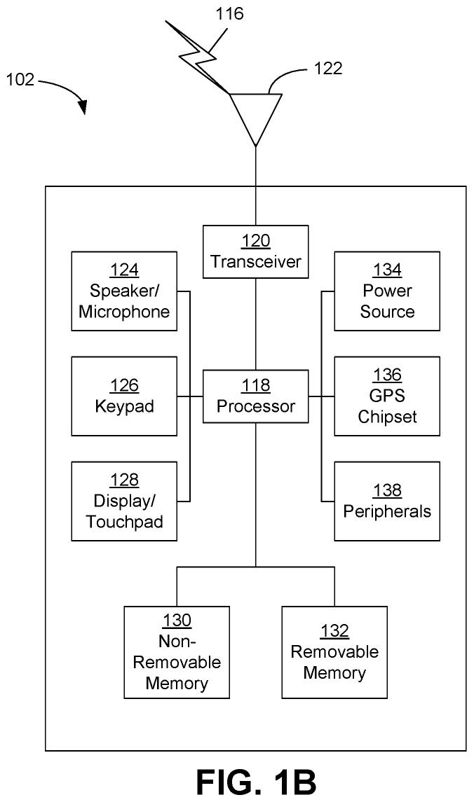

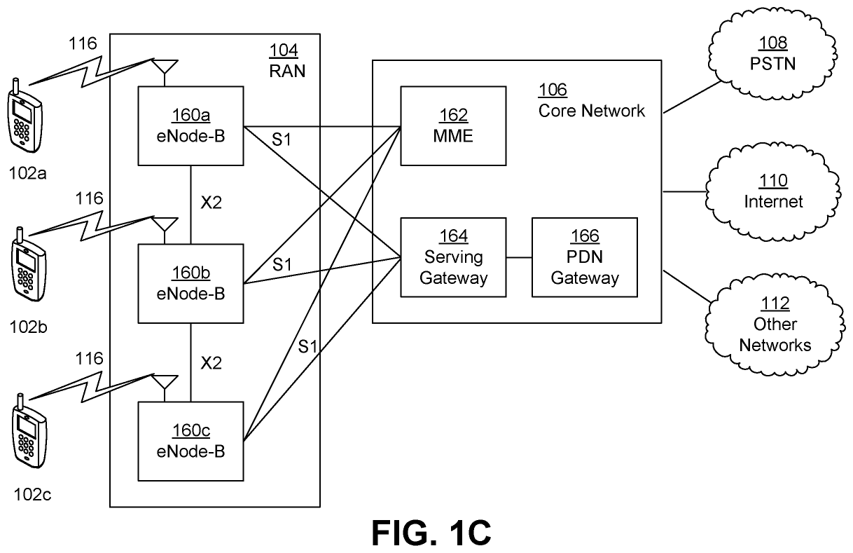

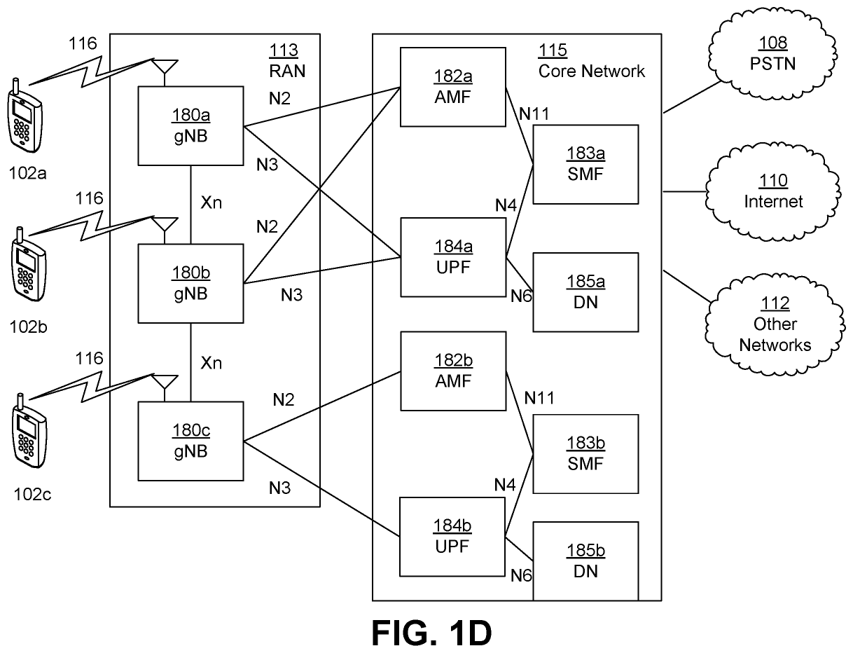

The methods, apparatuses and systems provided herein are well-suited for communications involving both wired and wireless networks. Wired networks are well-known. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160 a, 160 b, 160 c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology.

For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF a82a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Dual Connectivity

### Split Bearers in Dual Connectivity

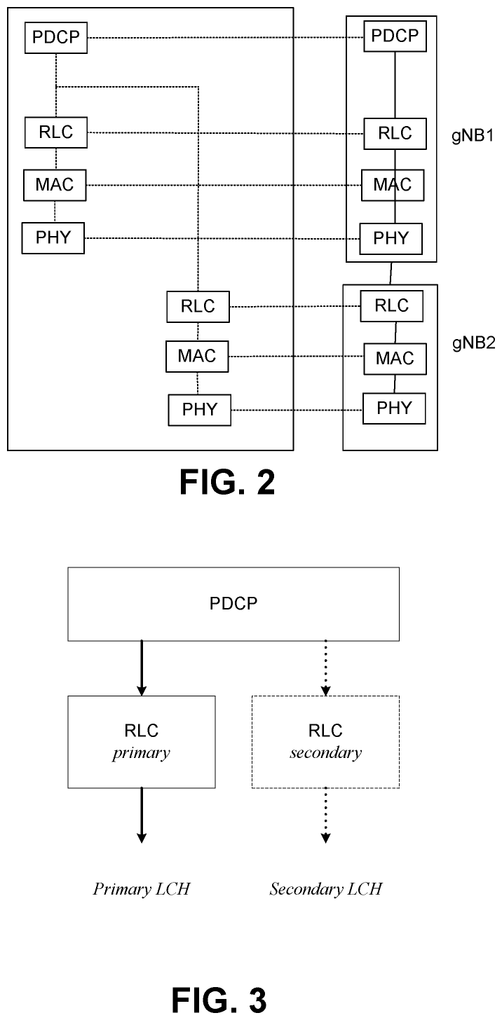

In Dual Connectivity (DC), a WTRU is being served by two nodes, each comprising a set of cells, known as the Master Cell Group (MCG) and the Secondary Cell Group (SCG), respectively. A bearer may be associated only with the MCG or the SCG, or it can be configured to be a split bearer. FIG. 2 shows the protocol view of a split bearer, wherein gNB 1 is in the MCG and gNB 2 is in the SCG.

Like any bearer, the WTRU will have one Packet Data Convergence Protocol (PDCP) entity associated with it, and the peer PDCP entity on the network side is terminated either at one of the gNBs (either the master or the secondary). In the downlink (DL), the Core Network (CN) sends the data to the gNB where the PDCP is terminated (gNB1 in FIG. 2 above), and it is up to the network to directly send the data to the WTRU via the link between that gNB and the WTRU, or forward the PDCP PDUs to gNB2 (e.g., via an Xn interface), and gNB2 will send the data to the WTRU via the link between itself and the WTRU.

In the Uplink (UL), the WTRU is configured with the path to the MCG as the primary path, and the path to the SGC as a secondary path. A threshold, known as the UL split buffer threshold, is also configured. If the UL buffer size for that bearer is less than this threshold, the PDCP will push the data only to the Radio Link Control (RLC) associated with the primary path. However, if the buffer size becomes larger than the threshold, then the WTRU can push the data to either path (i.e., left to WTRU implementation).

### Packet Duplication

Data duplication is a technique for ultra-reliable low-latency communication (URLLC) in fifth-generation cellular systems. It entails the use of multiple radio links, each delivering the same data between a terminal and the network to boost the transmission reliability.

When duplication is configured for a radio bearer by RRC, at least one secondary RLC entity is added to the radio bearer to handle the duplicated PDCP Packet Data Units (PDUs), as depicted in FIG. 3, where the logical channel (LCH) corresponding to the primary RLC entity is referred to as the primary logical channel, and the logical channel corresponding to the secondary RLC entity(ies) is referred to as the secondary logical channel(s). All RLC entities involved for duplication have the same RLC mode. Duplication in PDCP therefore comprises submitting the same PDCP PDUs multiple times: once to each activated RLC entity for the radio bearer. PDCP control PDUs are not duplicated and are always submitted to the primary RLC entity. With multiple independent transmission paths, packet duplication therefore increases reliability and reduces latency and is especially beneficial for URLLC services.

When configuring duplication for a Data Radio Bearer (DRB), Radio Resource Control (RRC) also sets the state of PDCP duplication (either activated or deactivated) at the time of (re-)configuration. After the configuration, the PDCP duplication state can then be dynamically controlled by means of a Medium Access Control (MAC) Control Element (CE) and, in DC, the WTRU applies the MAC CE commands regardless of their origin (MCG or SCG).

When duplication is configured for a Signaling Radio Bearer (SRB), the state of PDCP duplication is always active and cannot be dynamically controlled. When configuring duplication for a DRB with more than one secondary RLC entity, RRC also sets the state of each of them (i.e., either activated or deactivated). Subsequently, a MAC CE can be used to dynamically control whether each of the configured secondary RLC entities for a DRB should be activated or deactivated, i.e., which of the RLC entities shall be used for duplicate transmission. A primary RLC entity cannot be deactivated. When duplication is deactivated for a DRB, all secondary RLC entities associated with that DRB are deactivated. When a secondary RLC entity is deactivated, it is not re-established, the HARQ buffers are not flushed, and the transmitting PDCP entity should indicate to the secondary RLC entity to discard all duplicated PDCP PDUs.

When activating duplication for a DRB, the network ensures that at least one serving cell is activated for each logical channel associated with an activated RLC entity of the DRB; and, when the deactivation of SCells leaves no serving cells activated for a logical channel of the DRB, the network should ensure that duplication is also deactivated for the RLC entity associated with the logical channel.

When duplication is activated, the original PDCP PDU and the corresponding duplicate(s) shall not be transmitted on the same carrier. The logical channels of a radio bearer configured with duplication can either belong to the same MAC entity (referred to as CA duplication) or to different ones (referred to as DC duplication).

CA duplication can also be configured in either or both of the MAC entities together with DC duplication when duplication over more than two RLC entities is configured for the radio bearer. In CA duplication, logical channel mapping restrictions are used in a MAC entity to ensure that the different logical channels of a radio bearer in the MAC entity are not sent on the same carrier. When CA duplication is configured for an SRB, one of the logical channels associated to the SRB is mapped to SpCell.

When CA duplication is deactivated for a DRB in a MAC entity (i.e., none, or only one of the RLC entities of the DRB in the MAC entity remains activated), the logical channel mapping restrictions of the logical channels of the DRB are lifted for as long as CA duplication remains deactivated for the DRB in the MAC entity.

When an RLC entity acknowledges the transmission of a PDCP PDU, the PDCP entity shall indicate to the other RLC entity(ies) to discard it. In addition, in case of CA duplication, when an RLC entity restricted to only SCell(s) reaches the maximum number of retransmissions for a PDCP PDU, the WTRU informs the gNB but does not trigger Radio Link Failure (RLF).

### RLF and Recovery in Uu

RLF is monitored by the WTRU on the PCell in single connectivity. RLF is triggered when the T310 timer (started following a number of consecutive out of sync indications from the lower layers) expires. Upon RLF detection, the WTRU triggers re-establishment. If a WTRU is configured with conditional handover (CHO) and the cell selection performed following RLF results in a CHO candidate, the WTRU performs CHO to the CHO candidate cell instead of the prior cell.

For a WTRU in DC, the WTRU performs Radio Link Monitoring/Radio Link Failure (RLM/RLF) on the PCell of the MCG and the PSCell of the SCG. RLF is declared separately for the MCG and for the SCG.

If RLF is detected for the MCG, and fast MCG link recovery is configured, the WTRU triggers fast MCG link recovery. Otherwise, the WTRU initiates the RRC connection re-establishment procedure. During fast MCG link recovery, the WTRU suspends MCG transmissions for all radio bearers and reports the failure via MCG Failure Information message to the Master Node (MN) via the SCG, using the SCG leg of split SRB1 or SRB3.

The WTRU includes in the MCG Failure Information message the measurement results available according to current measurement configuration of both the MN (i.e., the node gNB associated with the MCG) and the Secondary Node (SN) (the node associated with the SCG). Once the fast MCG link recovery is triggered, the WTRU maintains the current measurement configurations from both the MN and the SN, and continues measurements based on configurations from the MN and the SN, if possible. The WTRU initiates the RRC connection re-establishment procedure if it does not receive an RRC reconfiguration message, MobilityFromNRCommand message, MobilityFromEUTRACommand message, or RRC release message within a certain time period after fast MCG link recovery was initiated.

Upon receiving an RRC reconfiguration message, MobilityFromNRCommand message, or MobilityFromEUTRACommand message, the WTRU resumes MCG transmissions for all radio bearers. Upon receiving an RRC release message, the WTRU releases all the radio bearers and configurations.

Upon SCG failure, if MCG transmissions of radio bearers are not suspended, the WTRU suspends SCG transmissions for all radio bearers and reports the SCG Failure Information to the MN, instead of triggering re-establishment. If SCG failure is detected while MCG transmissions for all radio bearers are suspended, the WTRU initiates the RRC connection re-establishment procedure.

In all SCG failure cases, the WTRU maintains the current measurement configurations from both the MN and the SN, and the WTRU continues measurements based on configuration from the MN and the SN, if possible.

The WTRU includes in the SCG Failure Information message the measurement results available according to the current measurement configuration of both the MN and the SN.

In the above, and in embodiments discussed below, re-establishment consists of a procedure whereby the WTRU 1) performs cell selection, and/or upon selection of a cell, transmits a re-establishment request RRC message.

### Relaying in a Wireless Communications Network

3GPP Release 17 has specified SL-based UE-to-Network Relays. Sidelink relay is introduced to support 5G ProSe UE-to-Network Relay (U2N Relay) function to provide connectivity to the network for U2N Remote WTRU(s). Both L2 and L3 U2N Relay architectures are supported. The L3 U2N Relay architecture is transparent to the serving RAN of the U2N Relay WTRU, except for controlling sidelink resources.

A U2N Relay WTRU shall be in RRC_CONNECTED state to perform relaying of unicast data.

For L2 U2N Relay operation, the following RRC state combinations are supported: 1) both U2N Relay WTRU and U2N Remote WTRU shall be in RRC CONNECTED state to perform transmission/reception of relayed unicast data; and 2) the U2N Relay WTRU can be in RRC_IDLE, RRC_INACTIVE or RRC_CONNECTED state as long as all the U2N Remote WTRU(s) that are connected to the U2N Relay WTRU are either in RRC_INACTIVE or in RRC_IDLE state. For L2 U2N Relay, the U2N Remote WTRU can only be configured to use resource allocation mode 2 for data to be relayed.

A single unicast link is established between one L2 U2N Relay WTRU and one L2 U2N Remote WTRU. The traffic of the U2N Remote WTRU via a given U2N Relay WTRU and the traffic of the U2N Relay WTRU shall be separated in different Uu RLC channels over Uu.

### L2 U2N Relay Protocol Architecture

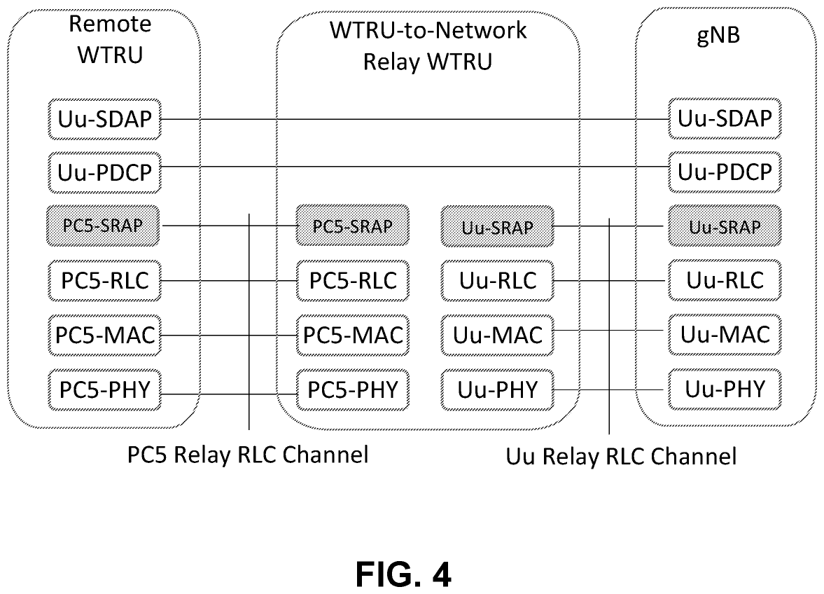

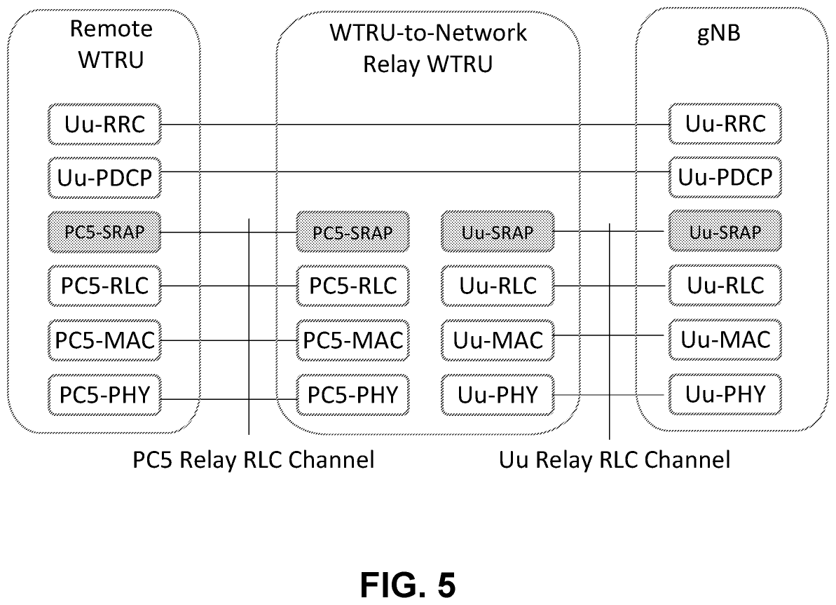

The protocol stacks for the user plane and control plane of the L2 U2N Relay architecture are presented in FIGS. 4 and 5, respectively. The Sidelink Relay Adaptation Protocol (SRAP) sublayer is placed above the RLC sublayer for both the Control Plane (CP) and User Plane (UP) at both the PC5 interface and the Uu interface. The Uu Service Data Adaptation Protocol (SDAP), PDCP and RRC are terminated between the L2 U2N Remote WTRU and the gNB, while SRAP, RLC, MAC and PHY (Physical) are terminated in each hop (i.e., the link between L2 U2N Remote WTRU and L2 U2N Relay WTRU and the link between L2 U2N Relay WTRU and the gNB).

For L2 U2N Relay, the SRAP sublayer over PC5 hop is only for the purpose of bearer mapping. The SRAP sublayer is not present over PC5 hop for relaying the L2 U2N Remote WTRU's message on the Broadcast Control Channel (BCCH) and the Paging Control Channel (PCCH). For the L2 U2N Remote WTRU's message on SRB0, the SRAP sublayer is not present over PC5 hop, but the SRAP sublayer is present over Uu hop for both DL and UL.

For L2 U2N Relay, for uplink:
The Uu SRAP sublayer supports UL bearer mapping between ingress PC5 Relay RLC channels for relaying and egress Uu Relay RLC channels over the L2 U2N Relay WTRU Uu interface. For uplink relaying traffic, the different end-to-end RBs (SRBs or DRBs) of the same Remote WTRU and/or different Remote WTRUs can be multiplexed over the same Uu Relay RLC channel;
The Uu SRAP sublayer supports L2 U2N Remote WTRU identification for the UL traffic. The identity information of the L2 U2N Remote WTRU Uu Radio Bearer and a local Remote WTRU ID are included in the Uu SRAP header at UL in order for the gNB to correlate the received packets for the specific PDCP entity associated with the right Uu Radio Bearer of a Remote WTRU;
The PC5 SRAP sublayer at the L2 U2N Remote WTRU supports UL bearer mapping between Remote WTRU Uu Radio Bearers and egress PC5 Relay RLC channels.

For L2 U2N Relay, for downlink:
The Uu SRAP sublayer supports DL bearer mapping at the gNB to map end-to-end Radio Bearers (SRB, DRB) of the Remote WTRU into the Uu Relay RLC channel over the Relay WTRU Uu interface. The Uu SRAP sublayer supports DL bearer mapping and data multiplexing between multiple end-to-end Radio Bearers (SRBs or DRBs) of a L2 U2N Remote WTRU and/or different L2 U2N Remote WTRUs and one Uu Relay RLC channel over the Relay WTRU Uu interface;
The Uu SRAP sublayer supports Remote WTRU identification for DL traffic. The identity information of the Remote WTRU Uu Radio Bearer and a local Remote WTRU ID are included into the Uu SRAP header by the gNB at DL in order for the Relay WTRU to map the received packets from the Remote WTRU Uu Radio Bearer to its associated PC5 Relay RLC channel;
The PC5 SRAP sublayer at the Relay WTRU supports DL bearer mapping between ingress Uu Relay RLC channels and egress PC5 Relay RLC channels;
The PC5 SRAP sublayer at the Remote WTRU correlates the received packets for the specific PDCP entity associated with the right Uu Radio Bearer of a Remote WTRU based on the identity information included in the Uu SRAP header. A local Remote WTRU ID is included in both PC5 SRAP header and Uu SRAP header. The L2 U2N Relay WTRU is configured by the gNB with the local Remote WTRU ID to be used in the SRAP header. The remote WTRU obtains the local Remote ID from the gNB via Uu RRC messages including RRCSetup, RRCReconfiguration, RRCResume, and RRCReestablishment. Uu DRB(s) and Uu SRB(s) are mapped to different PC5 Relay RLC channels and Uu Relay RLC channels in both PC5 hop and Uu hop.

It is the gNB's responsibility to avoid collision on the usage of the local Remote WTRU ID. The gNB can update the local Remote WTRU ID by sending the updated local Remote ID via a RRCReconfiguration message to the Relay WTRU. The serving gNB can perform local Remote WTRU ID updates independent of the PC5 unicast link L2 ID update procedure.

### Scheduling in Sidelink

Sidelink supports two scheduling modes—mode 1 and mode 2. For an in-coverage WTRU, the gNB can control whether a WTRU transmits using mode 1 or mode 2.

In mode 1 scheduling, which can be used for a sidelink WTRU in RRC_CONNECTED state, a WTRU receives SL grants directly from the network in Downlink Control Information (DCI). In this case, the WTRU reports buffer status for SL data grouped by a destination index (where a destination index corresponds to a unique L2 destination ID, or pair of source/destination L2 IDs). The WTRU can transmit an SL Scheduling Request (SR) if an SL grant is not available for transmission of the pending data.

In mode 2 scheduling, which can be used by a WTRU in any RRC state, or when a WTRU is out of coverage, a WTRU is configured with a resource pool from which it performs autonomous resource selection and scheduling. Resources are selected by the WTRU based on information in previous Sidelink Control Information (SCI) transmissions by other WTRUs (i.e., sensing results).

### Multipath Operation

Release 17 of the 3GPP specifications has introduced layer 2 WTRU to network relays. The main use case considered is the case of a remote WTRU out of coverage. In Release 18, however, specification of multipath is expected. In multipath, the remote WTRU is assumed to be in coverage and can therefore utilize either the Uu path, SL (relayed) path, or both. The description of the multipath work for Rel18 is as follows [2]:

Study the benefit and potential solutions for multi-path support to enhance reliability and throughput (e.g., by switching among or utilizing the multiple paths simultaneously) in the following scenarios [RAN2, RAN3]:
A. A WTRU is connected to the same gNB using one direct path and one indirect path via 1) Layer-2 WTRU-to-Network relay, or 2) via another WTRU (where the WTRU-WTRU inter-connection is assumed to be ideal), where the solutions for 1) are to be reused for 2) without precluding the possibility of excluding a part of the solutions which is unnecessary for the operation for 2).

In multipath operation, the direct link between the remote WTRU and the gNB, as well as the backhaul link between the relay WTRU and the gNB may be served by the same gNB, or even by the same cell of the same gNB. Also, if mode1 was chosen for the scheduling of the SL between the remote WTRU and the relay WTRU, the scheduling of all the links (Uu between remote WTRU and gNB, backhaul Uu between relay WTRU and gNB, and SL between the remote and relay WTRU) is performed by the gNB. Even if mode2 is used and a resource pool was pre-configured by the gNB for the SL which the remote WTRU can use autonomously, the gNB is still the one deciding the resource pool configuration, and thus has a control over the scheduling over the SL (even though it is not as real-time as in the case of mode1).

Multipath can be modelled similarly to DC from a protocol architecture perspective, as different MAC entities are used for the Uu link and the SL, and the same PDCP entity is configured for a given bearer that is using the multipath (e.g., a split bearer). However, if the same gNB is serving the cells of the Uu and the SL, then one may consider this to be similar to the case of CA (Carrier Aggregation). However, in CA, one MAC entity is utilized, which is not really the case shown here. To complicate matters even further, the Uu and the SL maybe be served by the same cell of a given gNB (i.e., not even CA).

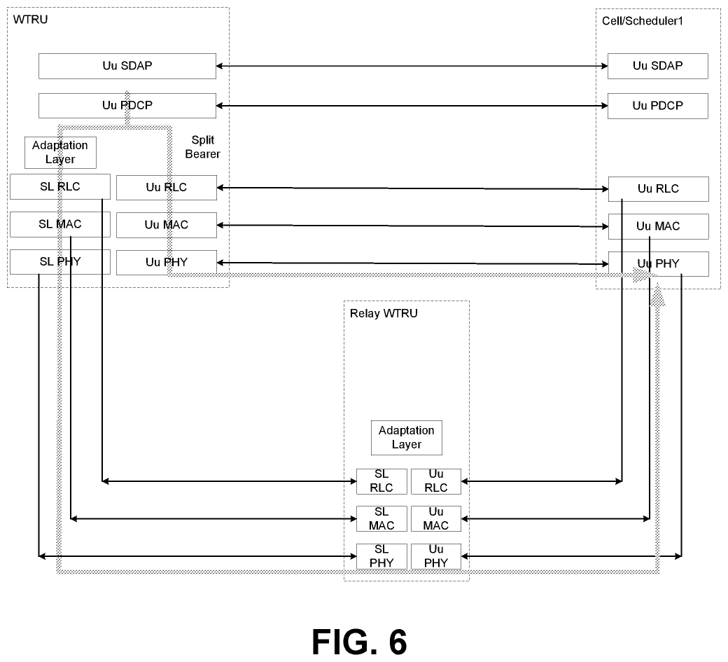

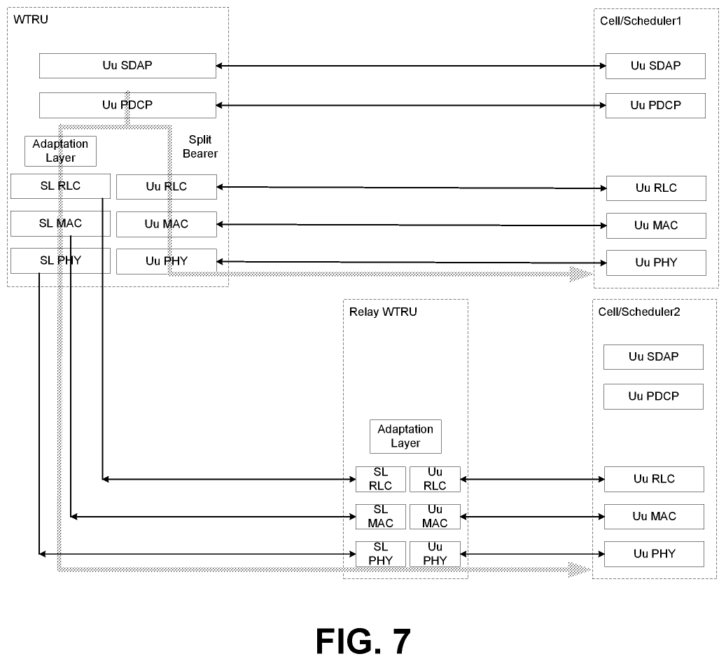

FIGS. 6 and 7 illustrate examples of how the multipath can be modelled at the protocol level. FIG. 6 illustrates multipath for the same cell, while FIG. 7 illustrates a multipath example to two different cells.

### RLF Failure and Recovery in Multipath Sidelink

Multipath may involve the same scheduler controlling a remote WTRU's Uu and SL paths. As a result, a bearer (including SRBs) can be configured to use either path. Unlike DC, with multipath there is no master node concept, and both paths are terminated in the same node of the network. As a result, monitoring the radio link on both paths simultaneously at the remote WTRU may be unnecessary and may result in unnecessary power consumption. Which link the WTRU should monitor for RLF should also be synchronized with the link the network may use to send RRC signaling. However, the RLM/RLF mechanism to be used may depend on whether multipath is used to ensure reliability (i.e., both paths are important) or to maintain coverage (i.e., the ability to maintain the connection via only a single path is needed).

For the case of multipath where one path is via a SL relay, RLF is detected based on HARQ feedback instead of normal RLM. This mechanism for RLF detection may be less reliable, especially when the amount of data sent via the SL path is limited.

Finally, recovery actions for multipath may also depend on the above factors and need to be defined for multipath in a way that is different for DC, given the absence of a master node.

### Multipath Communications

In the embodiments discussed herein, a remote WTRU in multipath refers to a WTRU connected to the network via two different paths-a direct Uu path and a path via a SL WTRU to a network relay. The connection via the two paths can be to the same gNB/scheduler (i.e., the remote WTRU and the relay WTRU are under the control of the same gNB) or to different gNB/schedulers (i.e., the remote WTRU and the relay WTRU are under the control of different gNBs). However, the embodiments discussed herein may be equally applicable to multiple paths (more than one), or to the case where two or more paths via SL WTRU to network relay WTRUs are maintained by the remote WTRU.

Representative Procedure for a WTRU to Recognize an inter-gNB Change Performed by a Relay WTRU

### Methods for Determining Whether Cells Belong to the Same/Different gNB

Embodiments for RLM/RLF herein may depend on knowledge at the WTRU of whether two cells (e.g., the cell associated with the direct path and the cell associated with the indirect/relayed path) belong to the same gNB or different gNBs. The remote WTRU may perform a different procedure described herein depending on whether the cells are associated with the same gNB or different gNBs. Such information may be determined using any of the following solutions:
List of cells:
   For example, the network may provide a list of cells associated with a specific cell (e.g., the cell of the direct path). If another cell is within this list of cells, the remote WTRU determines that cell is part of the same gNB as the specific cell
Identity broadcast/transmitted by the cell
   For example, a cell may transmit (e.g., in a System Information Block (SIB) or by dedicated RRC signaling) an identity that is used to determine whether two different cells are associated with the same gNB. For example, if the cells transmit the same identity, the WTRU can assume they are part of the same gNB
Explicitly as part of a procedure initiated by the network (e.g., HandOver (HO), reconfiguration, etc.)
   For example, a remote WTRU may be connected in multipath with a direct link to cell 1 and an indirect link via a relay that is connected to cell 2. Cell 1 and cell 2 may belong to the same gNB. The relay WTRU may receive a HO command from the network and may inform the remote WTRU of it. The remote WTRU, upon reception of the HO command, may need to determine whether the target cell (cell 3) is part of the same gNB or not. This may be indicated directly by the network using a flag or indication in the HO command itself. Specifically:
      The relay WTRU may receive, in the HO command, an indication to be forwarded to the remote WTRU in the notification message. Specifically, if the indication is sent (e.g., a flag is set to true), such a HO may represent an inter-gNB HO at the relay WTRU.
      The relay WTRU may include the indication or flag in the notification message to the remote WTRU
      The remote WTRU,
         upon reception of a HO notification with the indication that the source cell and the target cell are associated with different gNBs, may perform a procedure (described herein) associated with inter-gNB HO
         upon reception of a HO notification without the indication that the source cell and the target cell are associated with different gNBs, may perform a procedure (described herein) associated with intra-gNB HO (i.e., the indirect path and the direct path are associated with the same gNB)

### Representative Procedure for RLM/RLF in Multipath

### A Remote WTRU in Multipath Determines the Path on Which RLM/RLF Is Monitored

In one solution, a remote WTRU may determine which path to perform RLM/RLF on based on one or more, or any combination of the factors below. Although not explicitly mentioned in the examples below, similar factors may be used to determine the properties of the RLM/RLF that is performed, which may include the configuration used (e.g., whether to use a first set of parameters, timers, constants, etc. associated with RLM/RLF determination or a second set of parameters) and/or the intensity (whether to use normal RLM or relaxed RLM) and/or other aspects of the RLM/RLF. Furthermore, a remote WTRU may determine whether/how to perform RLM/RLF on one path (e.g., direct or indirect) based on the conditions associated with the other path (indirect or direct) where such conditions are described in the factors below. Combinations of the below factors may be considered when determining whether/how to perform Uu RLM/RLF and/or whether/how to perform SL RLF. In some embodiments, a first condition may be used to determine a second condition to be used in the determination. Specifically, the factors may include:
Measurements of the Uu path quality:
   For example, the WTRU may perform RLM/RLF on the Uu path if the measured RSRP on the Uu path is below a threshold and may stop performing RLM/RLF on the Uu path if the measured RSRP on the Uu path is above a threshold. The motivation for such an approach is that the WTRU can assume RLM/RLF on the Uu path is unnecessary when the Uu link has good path quality if it can assume there is a SL path to fall back on.
      For example, (1) the WTRU may perform RLM/RLF on the Uu path if the measured RSRP on the Uu path is below a first threshold, (2) it may perform relaxed RLM/RLF on the Uu path if the measured RSRP on the Uu path is between a first threshold and a second threshold, and (3) it may not perform any RLM/RLF if the measured RSRP on the Uu path is above a second threshold.
      For example, the WTRU may perform RLM/RLF on the Uu path if the measured RSRP on the Uu path is above a threshold, and may perform RLF on the relayed path only if the measured RSRP on the Uu path is below a threshold. These two thresholds may be the same or different thresholds. The motivation of such an approach is that, for a large Uu RSRP, the network may transmit RRC signaling on the Uu path, and the WTRU should monitor RLF based on the Uu path alone
Measurements of the SL path quality
   For example, the WTRU may perform RLM/RLF on the Uu path if the SL quality (e.g., SL RSRP) is above/below a threshold
      For example, a combined criteria of Uu and SL quality may be considered to determine which link(s) to perform RLF on. For example:
         If the SL RSRP is above a threshold, and the Uu RSRP is above a threshold, the WTRU may perform RLF on the SL path only. If the SL RSRP is below a threshold, or the Uu RSRP is below a threshold, the WTRU may perform RLF on the Uu path, and whether RLF is measured on SL may depend on other factors discussed herein. The advantage of such an approach is that the WTRU can turn off Uu RLM monitoring if it is sure it has a good enough SL link as a backup.
         If the SL RSRP is above a first threshold, and the Uu RSRP is above a second threshold, the WTRU may perform RLF on either the SL path or the Uu path (as determined by the WTRU or configured by the network). Otherwise, it may perform RLF on both paths.
         If the SL RSRP is below a first threshold and the Uu RSRP is below a second threshold, the WTRU may perform RLF on both paths. Otherwise, it may perform RLF on one link (determined by the WTRU or configured by the network).
SL specific measurements, such as CBR
   For example, the WTRU may perform RLM/RLF on the Uu path if the SL Channel Busy Ratio (CBR) is above a threshold. The advantage of such an approach is that, in the case where there is congestion on the SL, Uu RLM is maintained, regardless of whether the Uu RSRP is good.
Presence or amount of UL data being sent in the SL path, or in the Uu path
   This can be measured based on the amount of data routed by Packet Data Protocol (PDP), the amount of data in the WTRU's SL RLC buffers, or the Channel Occupancy Ratio (CR) measured on sidelink
   For example, the WTRU may perform RLM/RLF on the Uu path if the SL CR is above a threshold. The advantage of such an approach is that the WTRU can be sure that there is sufficient data being sent by the WTRU via the SL path to ensure a reliable HARQ-based RLF mechanism for monitoring the multipath link.
   For example, the WTRU may perform RLM/RLF on the Uu path if the WTRU has data for a SL logical channel with HARQ feedback enabled
Messages received from the relay WTRU
   In one embodiment, the remote WTRU may change its RLM/RLF behavior based on reception of a Uu RLF indication from the relay WTRU. Specifically, if the remote WTRU is not monitoring RLM/RLF on the Uu path at a given time and receives a Uu RLM/RLF indication from the relay WTRU, it may inform the network of this via Uu, and then initiate/resume RLM/RLF on the Uu path. The WTRU may continue to perform RLM/RLF on the Uu path until reconfigured with a new relay WTRU, or until indication (from the network or the relay WTRU) that the Uu link at the relay WTRU has been recovered.
   In one embodiment, the remote WTRU may change its RLM/RLF behavior based on flow control messages received from the relay WTRU. Specifically, the remote WTRU may receive flow control indications from the relay. If the flow control messages indicate that the remote WTRU should reduce the data rate via the relay WTRU, the remote WTRU may perform RLM/RLF via the Uu path. Otherwise, the remote WTRU may perform relaxed or no RLM/RLF via the Uu path.
QoS/Bearer configuration at the remote WTRU
   For example, the conditions for using the SL path for RLF may be further conditioned on the WTRU being configured with at least one SL LCH with HARQ feedback configured
   For example, the conditions for using the SL path for RLF may be further conditioned on the WTRU being configured with at least one SL RLC channel having RLC Acknowledged Mode (AM) configured
   For example, the WTRU may be allowed to use a first condition discussed herein for determining the RLF behavior for some QoS flows/bearers, and use a second condition discussed herein for determining the RLF behavior for some other QoS flows/bearers. For example, certain QoS flows/bearers, when established and/or when they have data available, may always require the WTRU to monitor RLM/RLF on the Uu path.
   For example, the remote WTRU may perform RLM/RLF on Uu based on the presence/number of SL LCHs configured with HARQ feedback enabled and/or the amount of data present for transmission in the buffers for such HARQ enabled LCHs. For example, the remote WTRU may monitor Uu RLM/RLF if all SL LCHs are configured without HARQ feedback enabled. For example, the remote WTRU may monitor Uu RLM/RLF if the number of SL LCHs configured with HARQ feedback enabled is above a threshold. For example, the remote WTRU may monitor Uu RLM/RLF if the amount of data buffered at the WTRU SL LCHs with HARQ feedback enabled is below a threshold. For example, the WTRU may use the above determination for whether to monitor Uu RLM/RLF when the cells associated with the direct link and the indirect link are the same and/or the WTRU is configured with a split SRB.
   For example, the remote WTRU may perform relaxed RLM/RLF on Uu when the number of SL LCHs configured with HARQ feedback enabled and/or the amount of data present for transmission in the buffers for such HARQ enabled LCHs is above a threshold. The WTRU may further determine the relaxation parameters associated with relaxed RLM/RLF (e.g., the percentage of reference signals to monitor, the value of a timer/counter associated with RLM/RLF, etc.) based on such condition.
Whether the relay and the remote WTRU are controlled by the same/different cell/scheduler/gNB
   For example, the WTRU may use a first rule or condition discussed herein in the same cell case, and a different rule or condition in a multiple cell case.
   For example, the WTRU may always perform RLF on both paths in the different cell case, but may use other conditions discussed herein to determine whether to perform RLF on both paths in the same cell case
Path configuration of the SRB in multipath
   For example, the WTRU may perform RLM/RLF on the Uu path, or have a rule which favors RLM/RLF detection on the Uu path if SRB is configured to be sent on the Uu path only, or have a rule which favors RLF monitoring on SL if SRB is to be sent on the SL path only, or have a rule that can flexibly determine the path based on RSRP (as discussed herein) if the SRB can be sent on both paths
Duplication configuration of the SRB in multipath
   For example, the WTRU may perform RLF on both Uu links and SL links if the SRB is configured for duplication
RRC state of the relay WTRU
   For example, the WTRU may be in multipath whereby the relay WTRU is in IDLE/INACTIVE, in which case all UL/DL data is routed via Uu. In such a case, the remote WTRU may always monitor RLM/RLF via Uu. When the relay WTRU is in CONNECTED state, the remote WTRU may use other rules for determining the RLM/RLF monitoring
Whether the path corresponds to the direct path or the indirect path
   For example, the WTRU may use a first rule (herein) for determining whether to monitor RLF on the direct path, and a second rule (herein) for determining whether to monitor RLF on the indirect path
   For example, the WTRU may always monitor RLF on the indirect path, and may determine whether to monitor RLF on the direct path based on another rule herein
Whether the indirect path is associated with a 3GPP link (e.g., PC5) or a non-3GPP link p2 For example, if the indirect path is associated with a 3GPP link (i.e., PC5), the remote WTRU may perform Uu RLM/RLF (or vice versa, i.e., the remote WTRU would perform SL RLM/RLF). Alternatively, if the indirect path is associated with a non-3GPP link, the remote WTRU may not perform Uu RLM/RLF (or vice versa, i.e., the remote WTRU would perform SL RLM/RLF). Alternatively, the remote WTRU may perform relaxed RLM/RLF on Uu when the indirect path is associated with a 3GPP link.
   A Remote WTRU May Initiate RLM/RLF Procedure on One Link When the Other Link Declares RLF and/or Failed Recovery

In one embodiment, a remote WTRU may initiate RLM/RLF on one link when the other link declares a failure. Such failure may be RLF of that link, failed re-establishment of that link, transmission of a failure RRC message (e.g., SCGFailure-like message or MCGFailure-like message), or any failure associated with the same conditions used to trigger RLF (e.g., a particular number of consecutive HARQ DTX on the link is reached). For example, a remote WTRU may be configured to monitor RLF on SL and Uu, but at a given time, may monitor only SL-based RLF. If the remote WTRU detects RLF on SL, the remote WTRU may initiate RLM/RLF monitoring on Uu. A remote WTRU may further use such operation only under conditions of a particular network architecture and/or bearer architecture for which such operation is configured. Specifically, such operation may be useful when the network sends RRC signaling on one path, and due to RLF on that path, may be expected to switch the path for RRC signaling to the other path. For example, the WTRU may initiate RLF on one path following detection of RLF on another path when any one or more of the following conditions applies:
a condition associated with the configuration of one or more bearer(s) (SRB or DRB). For example, the behavior may be applied when configured with split SRB without duplication. Specifically, the WTRU may perform RLM/RLF on both paths when split SRB is configured with duplication. When configured with SRB on a single path only, the WTRU may perform RLM/RLF on only that path, and initiate re-establishment when RLF is triggered
a condition associated with the relationship between the cells on the direct path and indirect path (e.g., same cell on both paths, cells belonging to the same gNB or configured cell list). For example, the behavior may be applied when the WTRU is configured with the same cell on both the direct and indirect path. Specifically, when configured with different cells on the different paths, RLF on one path may initiate an MCG-like failure procedure where the remote WTRU reports the failure and waits for further network configuration. On the other hand, when configured with the same cell on both paths, there may be no need to reconfigure the non-failed path and the WTRU may simply initiate failure monitoring instead on the non-failed path in the expectation of receiving RRC messages on the non-failed path
a condition associated with whether the WTRU-WTRU (indirect) link is an ideal link. For example, the behavior may be applied when the indirect link between the WTRUs is a non-3GPP link. Specifically, when configured with a PC5 link, the remote WTRU may monitor RLF on both links; however, when configured with a non-3GPP link, the link is assumed to be ideal (and cannot fail) and the remote WTRU may rely on the relay WTRU to monitor RLM/RLF on Uu on its behalf.
a condition associated with whether the path in which RLF was triggered is the direct or indirect path. For example, the behavior may be applied when RLF is triggered on the indirect path, but not when RLF is triggered on the direct path. For example, the remote WTRU may always monitor RLF on PC5-RRC since there is little additional power consumed for RLM monitoring compared to Uu.
a condition associated with the type of SL RLF that may be triggered. Specifically, the behavior may be applied only for certain cases of SL failure, such as, only when SL RLF based on HARQ DTX is triggered, only SL RLF based on T400 expiry is triggered, only SL RLF based on reception of Uu RLF indication from the relay WTRU is triggered, etc.

In a related embodiment, a WTRU may be performing relaxed RLM on one path and may initiate normal RLM/RLF when RLF (or a similar failure event) occurs on the other path.

### A Remote WTRU Routes Data via the SL Path Based on Conditions Related to the RLM/RLF

In one embodiment, a WTRU may modify the routing rules for UL data on split bearers based on the configuration of SRB and or other factors which may define its RLF behavior/requirements. Specifically, a WTRU, based on other rules discussed herein, may be required to monitor RLF on SL. If the WTRU has such a requirement, the WTRU may perform routing via the SL path such that sufficient data is sent via the SL path for an UL split bearer. For example, the WTRU may be configured with a percentage of data, possibly for each split bearer, to be routed via the SL path and may ensure that percentage is met whenever other conditions (described herein) require the WTRU to monitor RLF on SL. For example, the WTRU may be configured with a different split bearer threshold (e.g., a value of 0) and the WTRU may apply that split bearer threshold based on conditions discussed herein (e.g., Uu and/or SL quality).

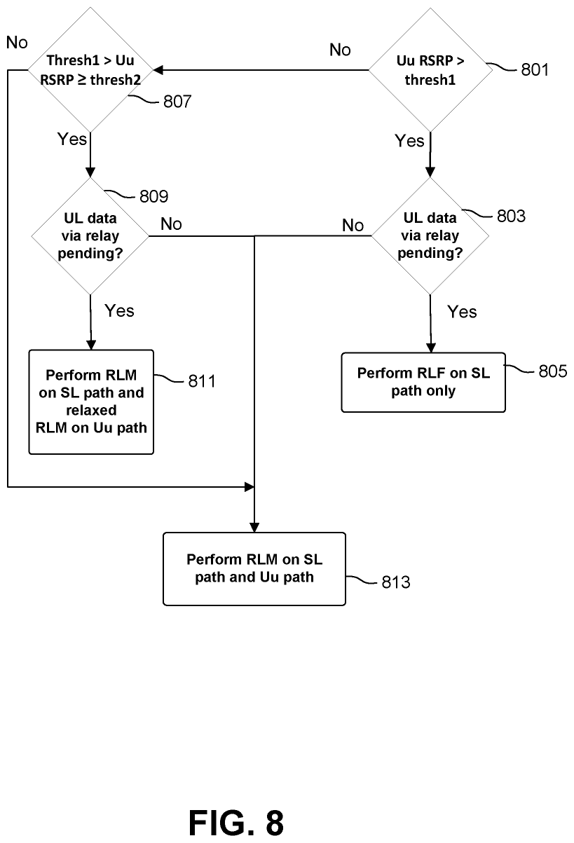

FIG. 8 is a flowchart demonstrating a process for performing RLM/RLF in a DC WTRU in accordance with one exemplary embodiment. In step 801, the WTRU determines if the RSRP is above a first threshold. If so, flow proceeds to step 803, where the WTRU determines if there is data pending for the relay path. If so, then the WTRU performs RLF on the SL relay path only (step 805). If, on the other hand, no data is pending for the SL relay path, the WTRU performs RLM on the SL relay path and relaxed RLM in the Uu path (step 813).

Returning to step 801, if the Uu RSRP is below the first threshold, flow proceeds to step 807, in which it is determined if the Uu RSRP is above a second threshold that is lower than the first threshold. If so, then flow proceeds to step 809, where the WTRU determines if it has UL data pending for the SL relay path. If so, then the WTRU performs RLM on the SL relay path and relaxed RLM on the Uu path (step 811). If not, then the WTRU performs RLM on both paths (step 813).

Although not depicted in the flowchart, in an embodiment, if and when RLF is triggered on one and only one of the two paths, recovery (e.g., a SGCFailure-like procedure) may be performed on the other of the two links. If RLF is triggered on both links, then radio link re-establishment is performed.

### Representative Procedure for Recovery in Multipath

### A Remote WTRU Determines the Recovery Procedure in Multipath

A remote WTRU may perform one or more of several recovery procedures upon detecting problems (e.g., RLF detection or indication from the relay WTRU) on one or both links. The remote WTRU may perform any, or several (e.g., in a sequence or at the same time) recovery procedures, including:
Perform Re-establishment procedure
Perform multipath re-establishment type 1
Perform multipath re-establishment type 2
Perform CHO procedure
Transmit a Uu RRC message, such as a failure message similar to an MCGFailure or SCGFailure message
Perform an MCGFailure-like procedure
   For example, transmit an RRC error message and initiate a timer. If the timer expires without reception of a reconfiguration by the network, initiate a re-establishment message
Perform an SCGFailure-like procedure
   For example, transmit an RRC error message but do not initiate a timer. Normal operation may continue over the link which is still operational
   For example, a WTRU may transmit a different RRC message depending on whether it initiates an SCGFailure-like procedure or an MCGFailure-like procedure
Perform a relay reselection procedure, possibly providing the results of reselection to the network
Perform conditional handover (CHO), HO, or a CHO-like procedure where the WTRU changes the PCell using a configuration provided to it, possibly to a different path, e.g., a path associated with multipath that was established or in the process of being established. For example, a cell addition received by the WTRU may initiate a HO or CHO-like procedure where the WTRU performs Pcell change to that cell as a result of some failure during the addition procedure, as described herein.
Trigger a measurement report of available/measured relays only, trigger a measurement report of available/measured cells only, trigger a measurement report of both measured relays and cells
   Specifically, conditions discussed herein may be used to determine which measurement report to be sent
Release the PC5-RRC connection
   Specifically, conditions discussed herein may be used to determine whether to keep or release the PC5-RRC connection
Release the multipath connection/configuration
   Specifically, conditions discussed herein may be used to determine whether to release the multipath connection/configuration at the remote WTRU, and rely on a single path connection
Indicate the cause of the RLF (e.g., SL-RLF detected or reception of Uu RLF from the relay WTRU)
   Specifically, conditions herein may be used to determine whether to include the cause of the RRC message sent to the network, such as SL-RLF detected, reception of Uu RLF, HARQ based SL RLF triggered, RLC-based SL RLF triggered, T400-based SL RLF triggered, etc.
Suspend one of the paths associated with the multipath configuration (i.e., suspend all transmissions performed to bearers associated with that path)

### A Remote WTRU Determines the Message Type/Contents/SRB-type of the Recovery Message (e.g., RRC Message) in Multipath

A Remote WTRU may include different content in the recovery message (e.g., MCGFailure-like message, SCGFailure-like message) or use a different RRC message altogether, possibly over a different SRB (SRB0 or SRB1). For example, a WTRU may or may not include a specific parameter in the message depending on a condition herein. Specifically, a remote WTRU may include any one or more of the following data in such a failure message:
Carrier frequency associated With the failed path
Measurements of other relay WTRUs
Indication, associated with the measurement of other relays, of whether the measurement result is associated with Sidelink Discovery Reference Signal Receive Power (SD-RSRP) or Sidelink Reference Signal Receive Power (SL-RSRP)
Indication, possibly associated with measurement of other relays, of whether the measurement result is associated with a relay in which the remote WTRU has a PC5-RRC connection or not
Indication, possibly associated with measurement of other relays, of whether the measurement result is associated with a relay WTRU in RRC_CONNECTED (or the state of the relay WTRU)
A failure type, failure indication, or similar information, which may indicate any of the following:
   RLF of the relay WTRU, or the RLF failure type of the relay WTRU (e.g., T310 expiry, randomAccessProblem, etc.)
   SL RLF detected by the remote WTRU
   HO by the remote WTRU
   Cell reselection by the remote WTRU
   Failure by the remote WTRU to establish an RRC connection
Indication that the failure occurred during the processing of an addition/change procedure (see re-establishment type 2 herein) The set of actions performed by the remote WTRU (e.g., the procedure) and/or the type/contents of the message may depend on any of the conditions discussed in the previous section. Specifically, the WTRU may perform one or more sets of actions versus one or another set of actions based on conditions associated with any or a combination of the following factors:

Measurements of the Uu path quality
Measurements of the SL path quality
SL specific measurements, such as CBR or CR
Messages received from the relay WTRU (i.e., the specific message or specific indication being sent)
QoS/Bearer configuration at the remote WTRU
Whether the relay and the remote WTRU are controlled by the same/different cell/scheduler/gNB
   For example, the remote WTRU may be configured with methods to determine if a second cell is part of the same gNB as the first cell (e.g., list of cells, subset of bits in the cell ID being common, area ID or similar broadcast by the two cells being the same, etc.).
Path configuration of the SRB in multipath
Duplication configuration of the SRB in multipath
RRC state of the relay WTRU
Path on which RLF was triggered (Uu/direct or SL/indirect or both)
RLF monitoring behavior (e.g., whether the WTRU is monitoring Uu RLF, SL RLF, whether the WTRU is performing relaxed Uu RLF monitoring)
RLF failure type itself
Whether the WTRU-WTRU connection of the indirect path is a 3GPP link (e.g., PC5) or a non-3GPP link (e.g., ideal link)
Which of the paths failed (direct or indirect)
Which path corresponds to the WTRU's Pcell, relative to which path failed

### Representative Procedure for Recovery Procedure and Message Contents

In one example embodiment, a WTRU that triggers Uu RLF alone may determine whether to perform MCGFailure-like procedure or SCGFailure-like procedure via the SL path based on whether the WTRU was transmitting UL data via the relay path, or has data pending for transmission via the relay path. For example, the WTRU may be configured with a threshold amount of data associated with SL LCHs with HARQ feedback enabled. If the amount of data in the buffers of all SL LCHs with HARQ feedback enabled is above a threshold, the WTRU may perform a SCGFailure-like recovery procedure. Otherwise, the WTRU may perform a MCGFailure-like recovery procedure.

In another example embodiment, a WTRU which detects SL RLF may determine whether to perform one of SCGFailure-like procedure, MCGFailure-like procedure, or re-establishment based on the measured Uu RSRP, possibly associated with the last reported measurement to the network, or associated with the last measurement performed at the WTRU. For example, if the measured Uu RSRP is above a first threshold, the WTRU may perform an SCGFailure-like procedure. If the measured Uu RSRP is between the first threshold and a second threshold that is lower than the first threshold, the WTRU may perform an MCGFailure-like procedure. If the Uu RSRP is below the second threshold, the WTRU may perform a re-establishment procedure.

In another example embodiment, a WTRU that triggers RLF on the SL path (or receives Uu RLF indication from a relay WTRU) may determine whether to perform a SCGFailure-like procedure, MCGFailure-like procedure, or re-establishment based on Uu RLM/RLF monitored by the WTRU at the time of the SL RLF. Specifically, if the WTRU is performing Uu RLM/RLF, the WTRU may perform MCGFailure-like procedure. If the WTRU is performing relaxed RLM on the Uu path, the WTRU may perform a MCGFailure-like procedure. If the WTRU is performing no Uu RLM, the WTRU may perform either a MCGFailure-like procedure or re-establishment, depending on other factors (e.g., Uu RSRP).

In another example embodiment, a WTRU that triggers RLF on one link may determine whether to perform MCGFailure-like procedure or SCGFailure-like procedure depending on whether the paths correspond to the same cell or different cells. Specifically, in the same cell case, the remote WTRU may perform SCGFailure-like procedure, while in the different cell case, the remote WTRU may perform MCGFailure-like procedure. In a similar example, the procedure followed may depend on which cell is configured as the serving cell. Specifically, if the RLF occurs on the path associated with the Pcell, the WTRU may perform MCGFailure-like procedure, while, if the RLF occurs on the path associated with the cell which is not the Pcell, the WTRU may perform SCGFailure-like procedure.

In another example embodiment, a WTRU that triggers RLF on one link may determine whether to perform MCGFailure-like procedure or SCGFailure-like procedure depending on whether the indirect path is a PC5 or a non-3GPP link. Specifically, if the indirect path is a non-3GPP link, RLF triggered on one link may initiate an MCGFailure-like procedure, or no failure procedure at all (i.e., the remote WTRU does not transmit any RRC message to the network). If the indirect path is PC5, the remote WTRU may initiate an SCGFailure-like procedure upon SL RLF and MCGFailure-like procedure upon Uu RLF.

In another example embodiment, the WTRU may determine the failure procedure steps based on the SRB configuration while in multipath. Specifically, if the WTRU detects RLF on a link that is not configured to carry SRB (e.g., the WTRU is configured with SRB1 only on one path) and RLF is detected on the link where SRB is not configured, the remote WTRU may report a failure message to the network, suspend or release bearers or transmissions to bearers on the failed link, and continue operation on the non-failed link. On the other hand, if the remote WTRU is configured with a split SRB, and the failure occurs on a link, the remote WTRU may report failure, suspend all transmissions, and wait for reconfiguration from the network. If reconfiguration is not received prior to expiry of a timer, the remote WTRU may trigger re-establishment. On the other hand, if the RLF occurs on the link where SRB is configured as non-split, the remote WTRU may trigger re-establishment.

In one example embodiment, a WTRU may include an RLF failure type indication when the recovery is performed via Uu, but may not include an RLF failure type indication when the recovery is performed via SL. For example, a remote WTRU may indicate in the error message on Uu whether the error was caused by SL RLF detection by the remote WTRU, reception of Uu RLF indication by the relay WTRU, or reception of other indication messages (e.g., handover (HO) indication from the relay WTRU). Specifically, the remote WTRU may include a failure type which represents the failure on the SL path.

In one example embodiment, a WTRU may determine the type of measurements (relay only, cell only, or both cell and relay) to include in a measurement report at the failure based on the link in which the failure occurred. Specifically, if Uu RLF was triggered, the WTRU may include measurements of cells only in the error message sent via the relay path. If SL RLF was triggered, the WTRU may include measurements of relays only in the error message sent via the Uu path. If the WTRU performs re-establishment, the WTRU may include measurements of both cells and relays.

In one example embodiment, a remote WTRU may release the PC5-RRC connection when it is in multipath and receives a HO indication from the relay WTRU and the HO is performed to a cell belonging to a different gNB. If the HO of the relay occurs to a cell of the same gNB, the remote WTRU may simply suspend transmissions via the relayed path and/or release the relay path configuration without releasing the PC5-RRC connection.

In another example, a WTRU may determine the behavior associated with the indirect link (RRC connection) and/or the bearers associated with the indirect link based on the type of failure that is triggered by the message in the remote WTRU. For example, if the remote WTRU receives a Uu RLF indication from the relay WTRU, the remote WTRU may release/tear down the PC5-RRC connection and/or release the multipath configuration. On the other hand, if the remote WTRU receives a HO indication from the relay WTRU, the remote WTRU may suspend indirect bearers or transmissions via the indirect link but maintain the PC5-RRC connection and wait for the network to reconfigure the indirect link. The remote WTRU may also wait for a period of time for a reconfiguration of the indirect link, after which it may release the PC5-RRC connection if the reconfiguration of the indirect link from the network is not received.

In another example, a WTRU may determine whether to report RLF/failure of the indirect path to the network based on the type of link (PC5 or non-3GPP link). Specifically, if the WTRU detects, or is informed of, a link failure from a relay WTRU, it may report the failure to the network when the link is a PC5 link. When the link is a non-3GPP link, the remote WTRU may not report the RLF/failure, but may instead simply suspend transmissions over the indirect link.

In another example, a WTRU may determine whether to report RLF/failure of the indirect path to the network based on the type of failure reported by the relay WTRU and/or the cell ID served by the relay. Specifically, a remote WTRU may receive a notification message with an indication type (HO, cell reselection, failure to establish RRC connection, Uu RLF, etc.). In some cases, for example the case of failure to establish RRC connection, Uu RLF, the remote WTRU may report RLF/failure of the indirect path to the network and then potentially suspend the multipath/bearers/transmission, as discussed herein. In other cases, for example the case of cell reselection, the remote WTRU may report failure to the network without taking any other actions related to its transmission and/or configuration. In yet other cases, for example HO, the remote WTRU may not report failure to the network and similar actions related to the bearers. Alternatively, whether the remote WTRU triggers a report may depend on whether the cell ID of the relay WTRU is part of the same or different gNB, as determined by the remote WTRU through comparison with a list. Whether the failure is reported or not, the remote WTRU may still suspend its bearers associated with the indirect link.

In one example embodiment, a WTRU that experiences RLF on both the Uu link and the SL link may perform a re-establishment procedure.

### Measurements of Relays in Multipath May Be Limited to Relays Connected to the Same Cell

In one embodiment, a WTRU may filter measurement of relays sent to the gNB so as to limit them to those relays served by the same cell/gNB as the cell/gNB serving the remote WTRU directly via multipath. For example, the WTRU may transmit measurements along with the error message during the recovery procedure following SL-RLF and may include potential relays and their SL-RSRP/SD-RSRP. In doing so, a remote WTRU that was in multipath at the time of the error may filter the measurements to include only the measurements of relays connected to the same cell/gNB as the remote WTRU.

Alternatively, the remote WTRU may prioritize transmission of measurements of relays connected to the same cell/gNB. Specifically, if the remote WTRU is able to detect relays, potentially with a SL RSRP/SD RSRP above a threshold, which are connected to the same cell, the WTRU may transmit only measurements of those relays. Otherwise, the WTRU may transmit measurements of other relays. The advantage of such an embodiment is to reduce the overhead of sending all relay measurements when multipath is limited to the case where the remote and the relay WTRU are controlled by the same cell.

Whether a WTRU filters measurements of relays to include only relays connected to the same gNB may further depend on other factors discussed herein. For example, during normal operation (e.g., not during RLF conditions), measurements of potential relays may be filtered to only those relays connected to the same gNB as long as the Uu RSRP is above a threshold. Otherwise, the WTRU may include all measurements.

The advantage of such an embodiment is that the WTRU may provide measurements of other relays (not necessarily controlled by the same cell) only when there may be a possibility of a change in cell by the network.

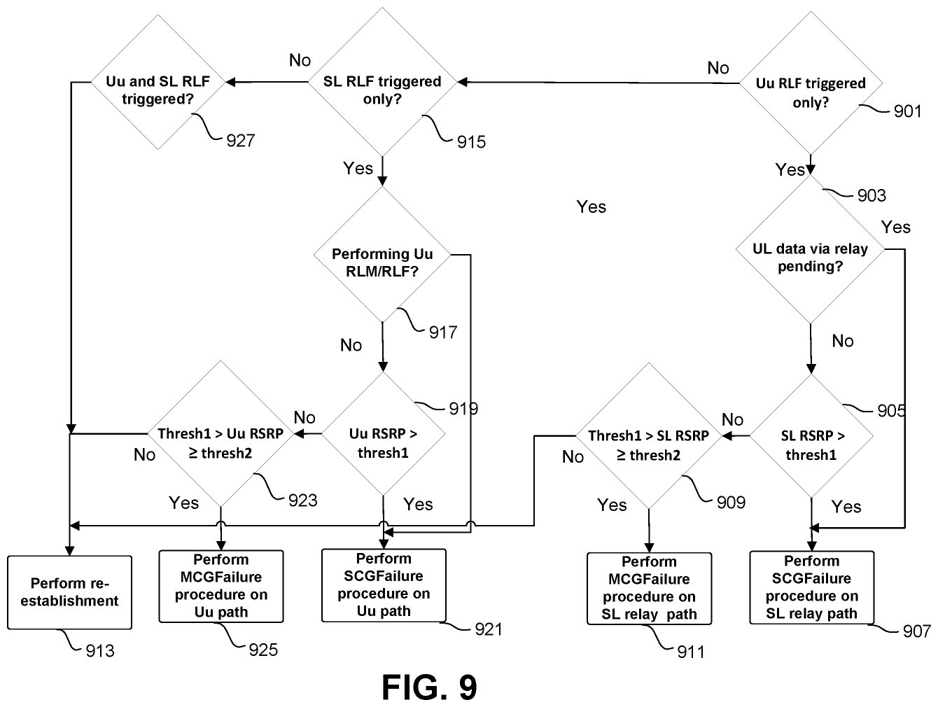

FIG. 9 is a flowchart of an exemplary procedure for performing radio link recovery in a DC WTRU upon RLF detection in accordance with one particular exemplary embodiment. At step 901, if RLF was triggered only on the Uu path, flow proceeds to step 903, where the WTRU determines if there is data pending for the SL relay path. If so, then the WTRU determines if the RSRP on the other path (in this instance, the SL relay path) is above a first threshold (step 905). If so, then the WTRU performs an SCGFailure like procedure (e.g., transmit an RRC message and continue operation on that path) on the SL relay path (step 907). If not, flow proceeds to step 909, where the WTRU determines if the RSRP on the SL relay path is above a second threshold that is lower than the first threshold. If so, then flow proceeds to step 911, where the WTRU performs a MCGFailure like procedure on the SL relay path (e.g., transmit an RRC message and set a timer for radio link re-establishment). If not, flow instead proceeds to step 913, in which the WTRU performs a radio link re-establishment procedure.

Returning to the top of FIG. 9, if, on the other hand, RLF was triggered only on the SL relay path (step 915), flow proceeds from step 915 to step 917, where the WTRU determines if it is currently performing RLM/RLF on the Uu path. If so, then flow proceeds from step 917 to step 919, where the WTRU determines if the RSRP on the Uu path is above a first threshold. If so, flow proceeds from step 919 to step 921, where the WTRU performs a SCGFailure like procedure on the Uu path. If not, flow instead proceeds from step 919 to step 923, where the WTRU determines if the RSRP on the Uu path is above a second threshold that is lower than the first threshold. If so, flow proceeds from step 923 to step 925, where the WTRU performs a MCGFailure like procedure on the Uu path. If not, then flow proceeds from step 923 to step 913, where the WTRU performs a radio link re-establishment procedure.

Returning again to the top of FIG. 9, if RLF was triggered for both paths (step 927), then flow proceeds straight to step 913, where the WTRU performs a radio link re-establishment procedure. Note that, although step 927 is shown in FIG. 9 as a decision step for sake of exposition, in actuality, step 927 may be omitted since the flowchart assumes that RLF was triggered. Thus, if the two conditions set forth in steps 901 and 915 are not satisfied, then the condition in step 927 is inherently satisfied.

### Representative Procedure—a Mac Ce That Can Switch Primary Path and Implicitly Initiate RLM/RLF

In one embodiment, a remote WTRU may receive a MAC CE that may initiate or stop RLM/RLF on a link and/or change the intensity (e.g., relaxed versus normal RLM) of the RLF. In another embodiment, a remote WTRU may receive a MAC CE that changes the applicability of a path for transmission/reception of SRB1. Specifically, a remote WTRU may be configured with split SRB, but, at a given time, may transmit/receive SRB and/or perform RLM/RLF only on one of the paths. The other path, although configured with SRB, may have SRB transmission/reception disabled on that path. Upon reception of the MAC CE, the remote WTRU may enable/disable SRB reception/transmission on a path. Specifically, when split SRB is configured, a remote WTRU with an RRC message may transmit the RRC message via the path(s) that has SRB enabled only.

In another embodiment, the same MAC CE may enable/disable RLM/RLF and enable/disable/change SRB transmission/reception on a path.

### Representative Procedure for Re-establishment in Multipath

New methods for re-establishment may be used by a remote WTRU in multipath. Specifically, re-establishment may be triggered by a WTRU in multipath because the WTRU is currently not configured to monitor SRB on one of the two paths (e.g., to save power). If RLF is triggered on the path with SRB, the WTRU is unable to perform an MCGFailure/SCGFailure like procedure and may typically resort to re-establishment. However, the remote WTRU was already functioning on the other path, as this path was being used during multipath operation, and was likely functioning properly (e.g., the remote WTRU was receiving/transmitting data on this path and potentially reporting measurements of this path). A full legacy re-establishment procedure may therefore not be required.

Thus, in one family of embodiments, a remote WTRU may trigger a new RRC procedure whereby it initiates/continues a connection on one path of the multipath upon a failure that would normally lead to a re-establishment procedure. Potential difference(s) between such a new RRC procedure and a conventional re-establishment procedure may include:
The remote WTRU does not trigger a cell/relay selection, but instead performs the procedure directly to the cell/relay that it was using in multipath
The remote WTRU may (re)use an RRC configuration that is already available at the WTRU, rather than release the configuration and trigger a re-establishment
The remote WTRU may avoid re-establishing or resetting one or more protocol layers (e.g., data buffers are not necessarily flushed), as is the case with re-establishment.

In one particular embodiment of this type, the remote WTRU may apply the procedure using an RRC configuration for the new path that is already available and applied at the WTRU. Specifically, if the WTRU is operating in multipath and performs the procedure to one of the two paths, the WTRU can continue to use the configuration associated with the multipath for each of the protocol layers applicable to that path. This type of embodiment most resembles a re-establishment where the selection of the cell/relay is not needed and protocol layers are not reset. This procedure may be referred to herein as multipath re-establishment type 1.

In another type of embodiment, the remote WTRU may apply the procedure using an RRC configuration received in a message that was received (e.g., path change/path addition) prior to the procedure being triggered due to an error. Specifically, the remote WTRU may trigger the procedure as a result of a failure that occurred after reception of the RRC configuration. This type of embodiment most resembles a CHO where the configuration is received via an RRC message and is applied upon triggering of the failure. This procedure may be referred to herein as multipath re-establishment type 2.

### The Type of RRC Message Sent/received And/or SRB May Depend on Whether SRB1 Was Configured or Not

The re-establishment procedure for multipath may be triggered with an RRC message using SRB0 or SRB1.

For example, if the WTRU triggers type 1 procedure, whether SRB0 or SRB1 is used for the initial RRC message may depend on whether the path over which the procedure is performed (i.e., the path used for transmission of the message) was previously configured with SRB1. If configured with SRB1, the remote WTRU may transmit an RRC message on SRB1 (e.g., similar to an MCG/SCGFailure message). The remote WTRU may then expect a reconfiguration message. Similar to the MCGFailureInformation procedure in legacy systems, the remote WTRU may trigger re-establishment if reconfiguration is not received within a certain period of time. If not configured with SRB1, the remote WTRU may transmit an RRC message on SRB0 (e.g., similar to an RRCReestablishmentRequest). The remote WTRU may wait for a response message (e.g., similar to a reestablishment message). In either case, the remote WTRU may continue transmission on DRBs via the non-failed path and not perform any reset of the PHY/MAC/RLC layers on either path. Specifically, for the SRB0 case, data transmission may continue to be performed using the previous security key. SRB0 may use a specified configuration for transmission/reception of the RRC messages. Alternatively, transmissions on SRB1 messages may be used with the use of a specified/default configuration for SRB1 instead (considering SRB1 had not been previously configured on this path).

In the uplink RRC message, the remote WTRU may further indicate the reason for the failure (e.g., the RLF type or whether caused by SL RLF, etc.).

For example, if the WTRU triggers type 2 procedure after reception of an RRC message (but before the message was applied), whether SRB0 or SRB1 is used for the initial RRC message may depend on whether the received message (in the examples below, the RRC message performing the path addition) contained a configuration for SRB1 or not. If no configuration was provided, the WTRU may use SRB0 or may transmit the RRC message with a default or specified configuration, while, if the received message contained SRB1 configuration, the remote WTRU may use the configuration in the received message for transmitting the uplink RRC message. Further, the WTRU may not expect any response message, for example, in the case when SRB1 is used (i.e., the message may be similar to a complete message).

In the uplink RRC message, the remote WTRU may further indicate that a path addition/change failed and the remote WTRU applied the configuration provided in the path addition/change message to perform the re-establishment. The WTRU may further identify the specific configuration if there were multiple configurations which may have been provided to the WTRU.

In the case of type 2, data transmission via DRB can be initiated upon any of the following conditions:
Immediately following transmission of the uplink RRC message
Immediately following RACH procedure (if a direct path was intended to be added)
Immediately following establishment of the PC5-RRC connection (if an indirect path was intended to be added)
Following reception of a DL confirmation message
Depending on whether SRB0 or SRB1 was used (or whether it was part of the configuration associated with type 2)
   For example, if SRB0 was used, the WTRU may wait for reception of the response before initiating data transmission
   For example, if SRB1 was used, the WTRU may perform transmission of data immediately following or at the same time as transmission of the RRC message. The WTRU may further not expect any response message following transmission of the UL RRC message

### Representative Procedure for Multi-path Re-establishment Type 1 May Be Triggered As a Result of RLF of the Other Path

In one embodiment, the remote WTRU may perform multipath re-establishment type 1 via a first path as a result of RLF detected on a second path, where the first and second paths are the paths previously configured to the WTRU during multipath.

### Representative Procedure for Multi-path Re-establishment Type 2 May Be Triggered As a Result of Failure During Path Addition/change

In one embodiment, a remote WTRU may initiate a multipath re-establishment type 2 procedure as a result of a failure during a path addition/change procedure. For example:
Failure of the indirect path during addition of the direct path: A remote WTRU may receive a path addition for adding a direct path via the indirect path. During the addition, the remote WTRU may receive a notification from the relay WTRU (e.g., Uu RLF) or may trigger SL RLF. Upon reception of the notification, the remote WTRU may perform multipath re-establishment type 2 to the cell associated with the direct path. Specifically, the remote WTRU may transmit a complete message via the direct path. The remote WTRU may further indicate (e.g., within the complete message) that the remote WTRU has performed multipath re-establishment type 2 procedure rather than addition as a result of a failure in the indirect path during the procedure. Specifically, the remote WTRU may include an indication in the complete message. The remote WTRU may then operate with the direct path as the PCell (rather than assuming the PCell is on the indirect path). Specifically, the remote WTRU may use the received configuration whereby the bearers associated with the indirect path are assumed to be suspended and only the direct path bearer or bearer paths are used until further reconfiguration.
Failure of the direct path during addition of the indirect path: Similarly, a remote WTRU may receive a path addition via the direct path to add an indirect path. During the addition, the remote WTRU may trigger Uu RLF. Upon detection of Uu RLF, the remote WTRU may perform type 2 procedure to the cell associated with the indirect path and indicate such in the complete message.
Failure of the direct path during a change of the indirect path: A remote WTRU may receive a reconfiguration that changes the indirect path (i.e., to a different relay WTRU), and trigger Uu RLF during the path change procedure. As a result, the remote WTRU may initiate a type 2 procedure via the new indirect path.

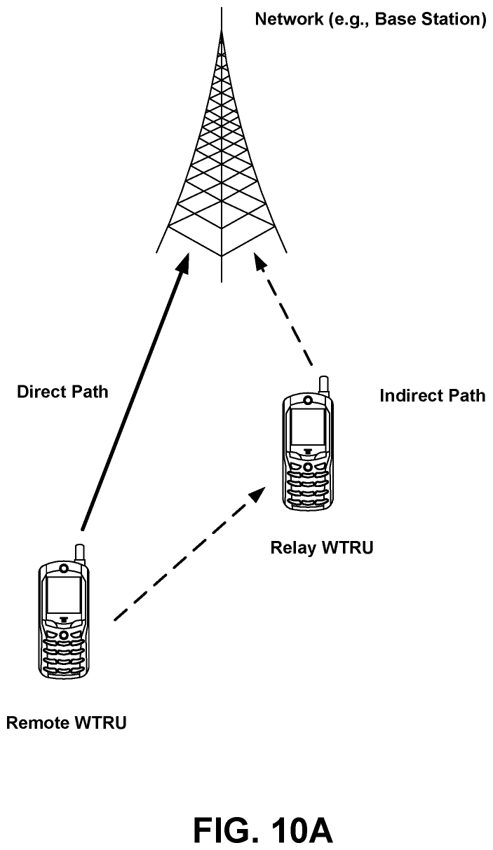

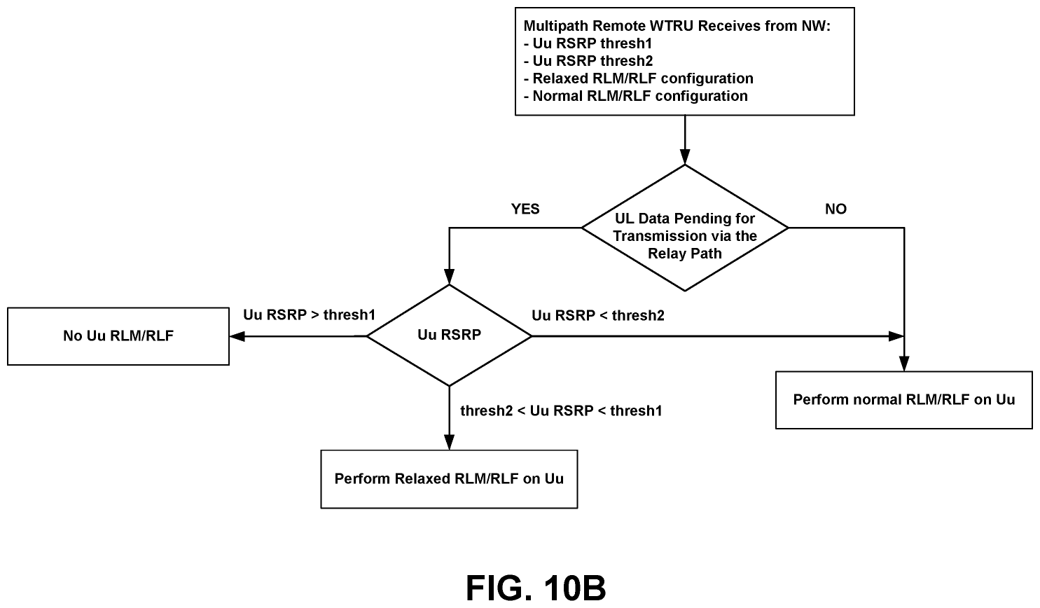

FIG. 10A provides an example of a multipath wireless communication. In this example, a remote WTRU is configured with multipath and performs RLM and RLF detection on Uu depending on 1) radio conditions on Uu and 2) the presence/amount of uplink data transmitted via the relay link (relay WTRU) to the network.

Referring to FIG. 10B, an example procedure of RLM and/or RLF detection in multipath communications is provided. In one embodiment, a WTRU (e.g., a multipath remote WTRU) for wireless communications comprising circuitry, including a transmitter, a receiver, a processor, and memory, is configured to receive configuration information indicating 1) a first radio link configuration and a second radio link configuration and 2) a first threshold and a second threshold, where the first threshold is greater than the second threshold. The WTRU may determine that uplink data is pending for transmission on a first transmission to a network entity via another WTRU (e.g., a relay WTRU), where the first transmission is associated with a first communication link. The WTRU may determine a channel condition of a second transmission from the network entity, where the second transmission is associated with a second communication link. The WTRU may perform a first radio link procedure using the first radio link configuration based on a measurement of the channel condition being greater than the second threshold and less than the first threshold.

In an example, the WTRU may perform a radio link failure (RLF) detection procedure on the first communication link based on the measurement of the channel condition being greater than the first threshold. In another example, the WTRU may perform a second radio link procedure using the second radio link configuration based on the measurement of the channel condition being less than the second threshold.

In various embodiments, the first radio link procedure comprises a radio link failure (RLF) detection, a radio link monitoring (RLM), and/or a radio link recovery on the second communication link. The second radio link procedure comprises a radio link failure (RLF) detection, a radio link monitoring (RLM), and/or a radio link recovery on the second communication link. Each of the first threshold and the second threshold is for comparing the channel condition associated with the second communication link. In some cases, the channel condition comprises a reference signal receive power (RSRP) of the second transmission. The measurement of the channel condition comprises a value of a measured reference signal receive power (RSRP) of the second transmission.

In some examples, the first communication link may be a sidelink (SL) relay path to communicate with the network entity via the second WTRU, and the second communication link may be a Uu path to communicate with the network entity.

In some examples, the configuration information indicates a radio resource control (RRC) configuration, and the WTRU may use the RRC configuration for the first or the second communication link prior to detecting an RLF. The WTRU may determine a type of radio link recovery procedure based on the channel condition, a type of an RLF, and/or the uplink data pending for transmission.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples.

Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 16 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

What is claimed is:

1-24. (canceled)

25. A wireless transmit/receive unit (WTRU) comprising:
a processor configured to:
establish a direct communication path with a network and an indirect communication path with the network, wherein the indirect communication path comprises a first path between the WTRU and a relay WTRU and a second path between the relay WTRU and the network;
receive a message from the relay WTRU that indicates that a failure of the second path occurred;
determine a failure of the indirect communication path based on the message received from the relay WTRU; and
sending a failure message to the network via a direct communication path, wherein the failure message indicates that the failure of the indirect communication path occurred over the second path between the relay WTRU and the network.

26. The WTRU of claim 25, wherein the failure message comprises measurement values based on whether or not the indirect communication path is a third generation partnership project (3GPP) communication path or a non-3GPP communication path.

27. The WTRU of claim 26, wherein the measurement values are reference signal received power (RSRP) values.

28. The WTRU of claim 25, wherein the processor is configured to:
suspend transmissions over the indirect communication path in response to detection of the failure of the indirect communication path.

29. The WTRU of claim 25, wherein the first path comprises a sidelink between the WTRU and the relay WTRU, and the second path comprises a Uu link between the relay WTRU and the network.

30. The WTRU of claim 25, wherein the direct communication path is a direct Uu communication path between the WTRU and the network.

31. A method performed by a wireless transmit/receive unit (WTRU), the method comprising:
establishing a direct communication path with a network and an indirect communication path with the network, wherein the indirect communication path comprises a first path between the WTRU and a relay WTRU and a second path between the relay WTRU and the network;
receiving a message from the relay WTRU that indicates that a failure of the second path occurred;
determining a failure of the indirect communication path based on the message received from the relay WTRU; and
sending a failure message to the network via a direct communication path, wherein the failure message indicates that the failure of the indirect communication path occurred over the second path between the relay WTRU and the network.

32. The method of claim 31, wherein the failure message comprises measurement values based on whether or not the indirect communication path is a third generation partnership project (3GPP) communication path or a non-3GPP communication path.

33. The method of claim 32, wherein the measurement values are reference signal received power (RSRP) values.

34. The method of claim 31, wherein the method further comprises:
suspending transmissions over the indirect communication path in response to detection of the failure of the indirect communication path.

35. The method of claim 31, wherein the first path comprises a sidelink between the WTRU and the relay WTRU, and the second path comprises a Uu link between the relay WTRU and the network.

36. The method of claim 31, wherein the direct communication path is a direct Uu communication path between the WTRU and the network.

37. A wireless transmit/receive unit (WTRU) comprising:
a processor configured to:
establish a direct communication path with a network and an indirect communication path with the network, wherein the indirect communication path comprises a first path between the WTRU and a relay WTRU and a second path between the relay WTRU and the network;
detect sidelink radio link failure (SL RLF) over the first path;
determine a failure of the indirect communication path based on the detection of SL RLF over the first path; and
transmit a failure message to the network via a direct communication path, wherein the failure message indicates that the failure of the indirect communication path occurred over the first path between the WTRU and the relay WTRU.

38. The WTRU of claim 37, wherein the failure message comprises a flag that indicates that the failure of the indirect communication path occurred over the first path.

39. The WTRU of claim 37, wherein the failure message comprises measurement values based on whether or not the indirect communication path is a third generation partnership project (3GPP) communication path or a non-3GPP communication path.

40. The WTRU of claim 37, wherein the processor is configured to:
suspend transmissions over the indirect communication path in response to detection of the failure of the indirect communication path.

41. The WTRU of claim 37, wherein the first path comprises a sidelink between the WTRU and the relay WTRU, and the second path comprises a Uu link between the relay WTRU and the network.

42. The WTRU of claim 37, wherein the direct communication path is a direct Uu communication path between the WTRU and the network.
